(19) United States
(12) Patent Application Publication
(10) Pub. No.: US 2002/0088854 A1
(43) Pub. Date: Jul. 11, 2002

(54) Method for providing delivery information on goods and delivery system employing the same

(76) Inventor: Hwan-Ju Jo, Suwon City (KR)

Correspondence Address: Robert E. Bushnell, Suite 300, 1522 K Street, N. W., Washington, DC, 20005, US

(21) Appl. No.: 09/986,386

(22) Filed: Nov. 8, 2001

(30) Foreign Application Priority Data
Jan. 4, 2001 (KR) 2001-280

(51) Int. Cl. G06F 17/60

(52) U.S. Cl. 235/385

(57) ABSTRACT

A technique and a delivery system provides for delivery information on goods. The technique includes the steps of attaching a storage storing information on a receiver to receive the delivery information on goods, reading the information in the attached storage on a delivery route and sending the information to a server, and providing the delivery information on the goods to the delivery information receiver based on receiver information by the server. With these steps, the technique provides the delivery information on the goods to the delivery information receiver during delivering.

### CLAIM OF PRIORITY

This application makes reference to, incorporates the same herein, and claims all benefits accruing under 35 U.S.C. §119 from an application for METHOD FOR SUPPLYING DELIVERY INFORMATION OF GOODS AND DELIVERY SYSTEM EMPLOYING THE SAME earlier filed in the Korean Industrial Property Office on Jan. 4, 2001 and there duly assigned Serial No. 2001-280.

### BACKGROUND OF THE INVENTION

1. Field of the Invention

The present invention relates to a method for providing delivery information on goods and delivery system employing the same.

2. Description of the Background Art

Generally, industrial samples, that is, all kinds of commercial goods, and post mails are delivered through a delivery system. The delivery of goods is made not only locally but also abroad according to an industrial development.

The delivery of goods in a conventional delivery system is made by first, a sender of goods provides information on goods to be delivered and a receiver to receive the goods to a delivery agency. Then, the delivery agency sends received goods to a collecting place. In the collecting place, goods to be delivered to various districts are collected. The delivery agency classifies goods for the districts to which the goods are delivered, based on the receiver information. Classified goods are sent to the receiver through a predetermined delivery route. Thus, the receiver receives the delivered goods.

However, the sender and the receiver of goods may not know the delivery information on the goods during delivering.

### SUMMARY OF THE INVENTION

It is therefore, an object of the present invention to provide delivery information on goods to a delivery information receiver during delivering.

It is another object to have a technique of efficiently without excess costs to provide information to a delivery information receiver during delivery.

It is yet another object to have a technique of providing delivery information on goods with high reliability.

The objects of the present invention are achieved by attaching a storage storing information on a receiver to receive the delivery information on the goods, reading the information in the attached storage on a delivery route and sending the information to a server, and providing the delivery information on the goods to the delivery information receiver based on receiver information provided by the server.

Here, a bar code is used as the storage storing information, and it is preferable that the storage stores therein at least one of an e-mail address and a telephone number of the delivery information receiver for providing the delivery information to the delivery information receiver.

Further, it is efficient to provide the delivery information through an e-mail or an SMS (short message service) from the server for easy receiving of the delivery information.

The delivery information is provided to the delivery information receiver by posting the delivery information on the server.

Further, it is preferable that the delivery information receiver is one of a sender or the receiver of the goods.

The object of the present invention is also achieved by a delivery system including a storage storing delivery information on a receiver to receive delivery information on goods, a reader reading the receiver information stored in the storage, and a server providing the delivery information on the goods to the delivery information receiver based on a read result from the reader part on a delivery route.

Here, a bar code is used as the storage, and it is preferable that the storage therein stores at least one of an e-mail address and a telephone number of the delivery information receiver for providing the delivery information to the delivery information receiver.

Further, the reader part includes a bar code reader, and it is preferable that the bar code reader provides the read delivery information through a network for directly sending received delivery information to the server.

Further, it is efficient to provide delivery information through an e-mail or a SMS (short message service) from the server for easy receiving of the delivery information receiver.

Further, it is preferable that the delivery information receiver is one of a sender or the receiver of the goods.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view showing a configuration of a delivery system according to the present invention;

FIG. 2A is a block diagram of a delivery system according to the present invention;

FIG. 2B is a block diagram of a delivery system of an alternate embodiment;

FIG. 3 is a flow chart showing a process of providing delivery information to a delivery information receiver in a delivery system according to the present invention;

FIG. 4 is a configuration screen provided to a delivery information receiver according to the present invention; and

FIG. 5 is a flow chart showing delivery process of a conventional delivery system.

### DETAILED DESCRIPTION OF THE EMBODIMENTS

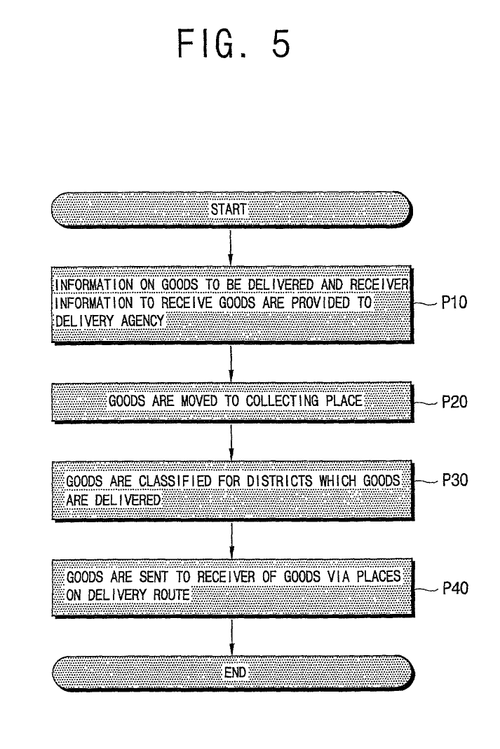

Turning now to the drawings, the delivery of goods in a conventional delivery system is made as follows, as shown in FIG. 5. Firstly, a sender of goods provides information on goods to be delivered and a receiver to receive the goods to a delivery agency (P10).

The delivery agency sends received goods to a collecting place (P20). In the collecting place, goods to be delivered to various districts are collected.

The delivery agency classifies goods for the districts to which the goods are delivered, based on the receiver information (P30). Classified goods are sent to the receiver via a predetermined delivery route (P40). Thus, the receiver receives the delivered goods.

However, the sender and the receiver of goods may not know delivery information on goods during delivering.

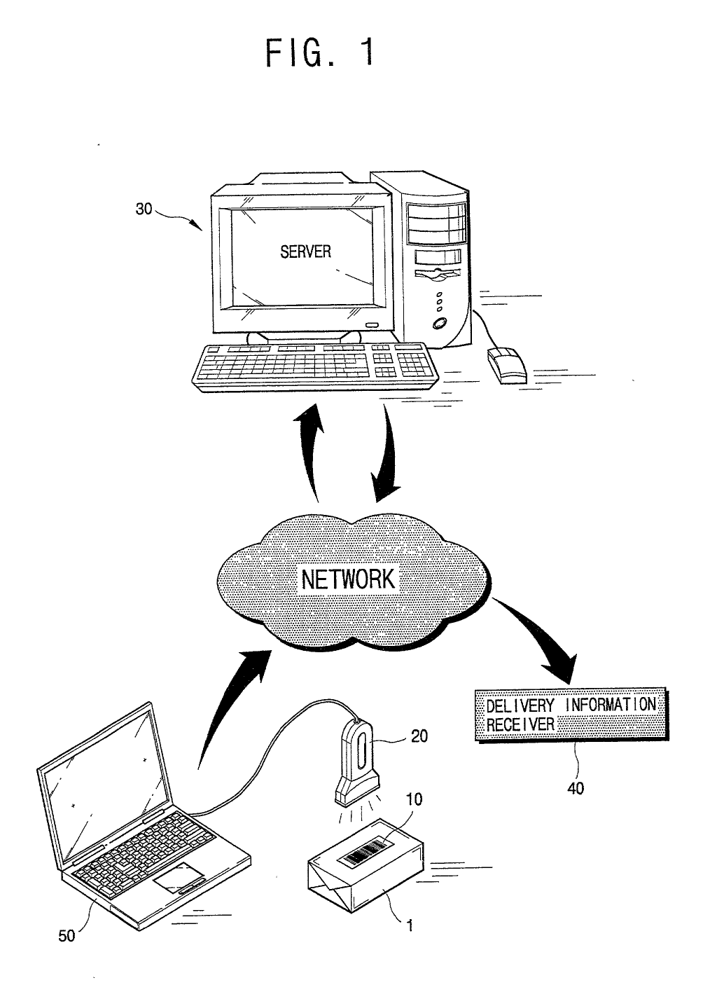

As shown in the drawings of FIG. 1, 2A, and 2B, the delivery system according to the present invention includes a bar code 10 attached on goods 1 and storing information on a delivery information receiver 40, a bar code reader 20 reading the delivery receiver information stored in the bar code 10, and a server 30 providing delivery information on goods to the delivery information receiver 40 after receiving the read result from the bar code reader 20.

The bar code 10 attached on goods as shown in FIG. 1 stores therein information on the delivery information receiver 40 who wants to receive the delivery information on the goods. The delivery information includes an e-mail (electronic mail) address, a telephone number of the receiver, and the goods information. Here, the delivery information receiver 40 is at least one of a sender and the receiver of goods.

The bar code readers 20 are provided in a collecting place in which goods are collected and a variety of districts on a predetermined delivery route. The bar code reader 20 reads the bar code 10 of goods and sends delivery information to the server 30, which is to be described later, through a network. The bar code reader 20 can be connected with a cellular phone (or other wireless device) 52 to send delivery information read through the network 60. However, in the present embodiment, the bar code reader 20 is connected with a portable computer 50 having a network function as shown in FIG. 1. Thus, the barcode reader 20 reads the bar code 10 attached on the goods and then sends delivery information to the server 30 in real time through a network 60. The delivery information may include a location of the bar code reader 20 which is sending delivery information in addition to the information on the delivery information receiver 40 and the goods in the bar code. The server 30 sends delivery information on goods 1 passing through the above steps to the delivery information receiver 40.

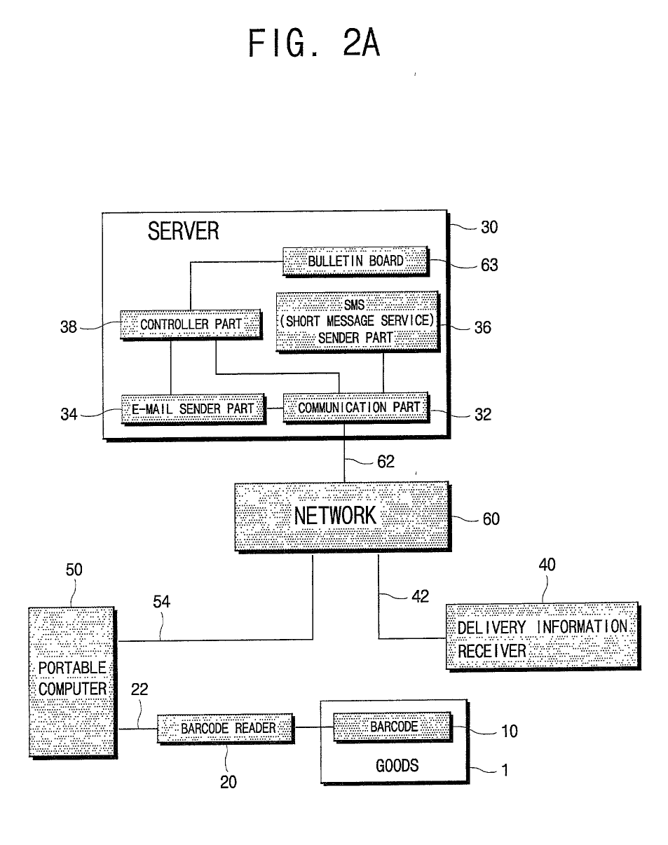

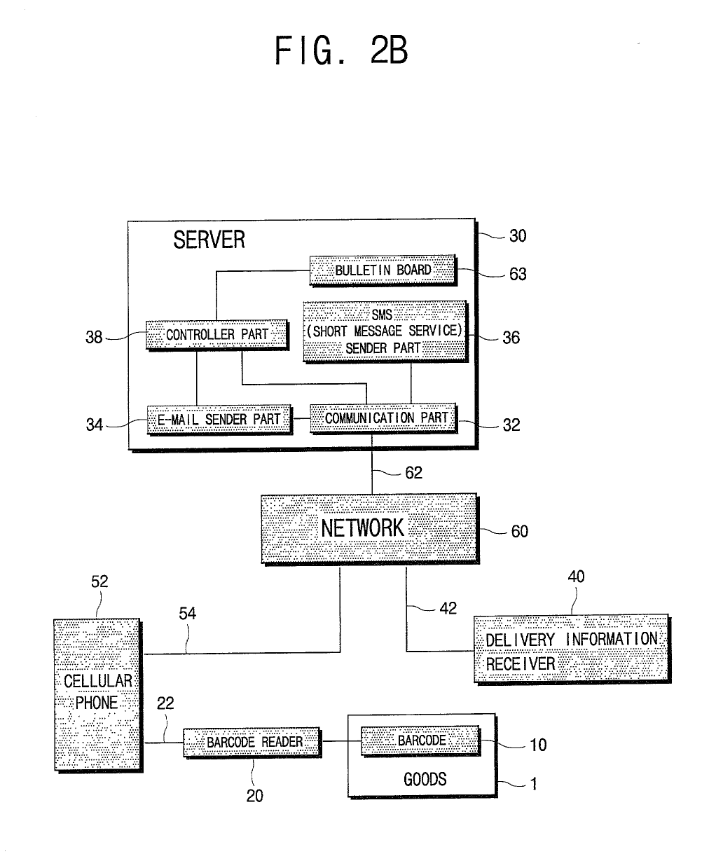

Referring to FIG. 2A and 2B, the connection 22 between the bar code reader 20 to the portable computer 50 (or cellular phone or other wireless device 52), the connection 54 between the portable computer 50 to the network 60, the connection 62 between the network 60 and the server 30, and the connection 42 between the network 60 and the delivery information receiver 40 can be wired or wireless.

The server 30 includes a communication part 32 for communicating through a network, an e-mail sender part 34 sending delivery information to the delivery information receiver 40 by an e-mail, a short message service (SMS) sender part 36 sending a SMS, and a controller part 38.

The communication part 32 receives the delivery information on goods 1 transmitted from the bar code reader 20 through a network 60 and sends the delivery information to the delivery information receiver 40 by the e-mail sender 34 and the SMS sender 36 under the control of the controller part 38.

The e-mail sender part 34 reads the e-mail address of the delivery information receiver 40 among the delivery information on goods 1 transmitted from the communication part 32 and sends the delivery information on goods 1 to the delivery information receiver 40 through the e-mail under the control of the controller part 38.

The SMS indicates a short message service with which users of cellular phones are able to send short messages each other. The SMS sender part 36 reads the telephone number of the delivery information receiver 40 among the delivery information on goods 1 transmitted from the communication part 32 and sends the delivery information on the goods 1 to the delivery information receiver 40, using the SMS on the network under the control of the controller part 38.

The controller part 38 provides the delivery information on goods 1 to the delivery information receiver 40 through the network 60 by controlling the e-mail sender part 34 and the SMS sender part 36 after receiving the delivery information on goods 1 transmitted from the communication part 32. Also, the controller part 38 can provide the delivery information to the delivery information receiver 40 through a bulletin board 63 formed in the server 30. In this case, the delivery information receiver 40 connects to the server 30 and then goes through a user verifying process in the controller part 38 to access the delivery information on goods 1. After the delivery information receiver 40 passes through the user verifying process, the controller part 38 provides a bulletin board 63 posted the delivery information to the delivery information receiver 40. Therefore, the delivery information receiver 40 can check through the bulletin board 63 where goods are in the delivery route.

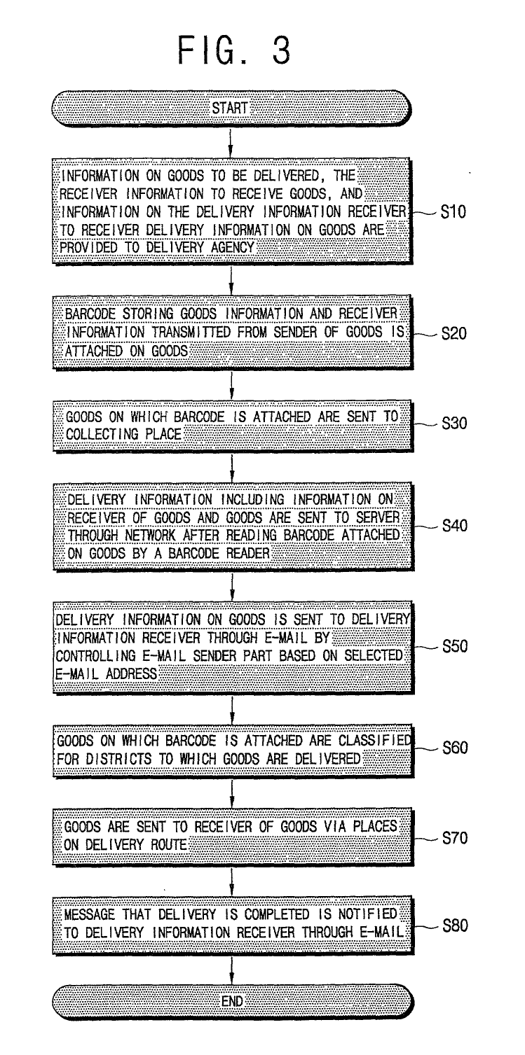

With this configuration of the delivery system according to the present invention, a process of providing the delivery information to the delivery information receiver will be described herein below, with reference to FIG. 3.

First, the sender of goods provides information on goods 1 to be delivered, the receiver information to receive goods, and information on the delivery information receiver 40 to receive delivery information on goods 1 to the delivery agency (S10).

The delivery agency attaches a bar code 10 on the goods 1. The bar code 10 stores goods information and the receiver information transmitted from the sender of goods 1 (S20).

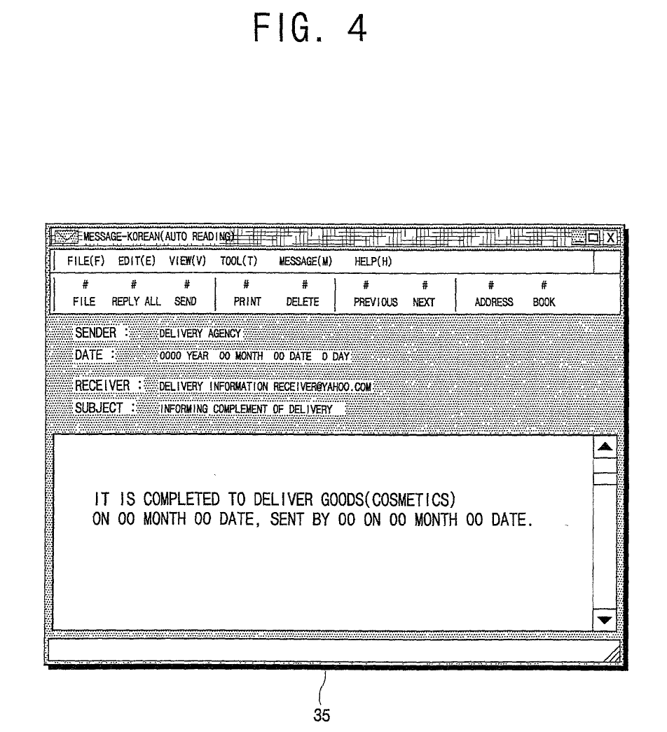

Goods on which the bar code 10 is attached are sent to the collecting place (S30). In the collecting place, goods 1 to be delivered to various districts are collected. Further, in the collecting place is provided the bar code reader 20 sending the delivery information on goods 1 to the server 30 by reading the attached bar code 10 on goods 1 through the network. The bar code reader 20 sends the delivery information on goods 1 such as information on the delivery information receiver, the receiver on the goods, goods, and the location of the bar code reader to the server 30 (S40). The controller part 38 of the server 30 selects out the e-mail address of the delivery information receiver 40 from the received delivery information through the communication part 32. The controller part 38 sends the delivery information on goods 1 to the delivery information receiver 40 through the e-mail by controlling the e-mail sender part 34 based on the selected e-mail address (S50). Goods 1 collected in the collecting place are classified for the districts to which the goods are delivered, based on the receiver information (S60). Classified goods are sent to the receiver 40 via places on the delivery route (S70). After goods 1 are sent to the receiver of goods, and after passing through step S40, a notifying message that delivery is completed is sent to the delivery information receiver 40 through the e-mail, as shown in FIG. 4 (S80). A configuration screen 35 provides the notifying message to the delivery information receiver 40.

Here, the bar code reader 20 connected with the network is provided in every place on the delivery route and reads the bar code 10 attached on goods 1. Read information is sent to the server 30 providing information, and then is sent to the delivery information receiver 40 by repeating the steps of S40 and S50.

As described above, it is preferable that the steps of S10 to S80 in FIG. 3 are performed sequentially. However, it is possible to move to the step of S80 after finishing the step of S40.

In the above embodiment, a barcode is used as storage for storing information as one example, however, it also possible to achieve the object of the present invention by preparing an IC chip which can store information therein. When the IC chip is used as the storage for storing information, an IC chip recorder for reading the information on the IC chip is used as the reader part so as to read delivery information on goods stored in the IC chip and then sending them to the server.

As described above, the method for providing delivery information on goods and the delivery system employing the same are provided by preparing a storage for storing information on the delivery information receiver on goods, a reader part reading the receiver information from the storage, and a server providing the delivery information transmitted from the reader part to a delivery information receiver.

Although the present invention has been described in connection with preferred embodiments thereof, it will be appreciated by those skilled in the art that additions, modifications, substitutions and deletions not specifically described may be made without departing from the spirit and scope of the invention as defined in the appended claims.

What is claimed is:

1. A method for providing delivery information on goods, comprising the steps of:
attaching a storage storing information on a receiver to receive the delivery information on the goods;
reading the information in the attached storage on a delivery route and sending the information to a server; and
providing the delivery information on the goods to the delivery information receiver based on the receiver information by the server.

2. The method according to claim 1, further comprised of a bar code being used as the storage.

3. The method according to claim 1, further comprised of the storage storing at least one of an e-mail address and a telephone number of the delivery information receiver.

4. The method according to claim 2, further comprised of the storage storing at least one of an e-mail address and a telephone number of the delivery information receiver.

5. The method according to claim 3, further comprised of the delivery information being provided through an e-mail from the server.

6. The method according to claim 3, further comprised of the delivery information being provided through a short message service from the server.

7. The method according to claim 3, further comprised of the delivery information being provided by posting the delivery information on the server.

8. The method according to claim 1, further comprised of the delivery information receiver being at least one of a sender and the receiver of the goods.

9. A delivery system, comprising;
a storage storing information on a receiver to receive the delivery information on goods;
a reader part reading the information of the receiver stored in the storage; and
a server providing the delivery information on the goods to the delivery information receiver based on a read result from the reader part on a delivery route.

10. The delivery system according to claim 9, further comprised of a bar code being used as the storage.

11. The delivery system according to claim 9, further comprised of the storage storing at least one of an e-mail address and a telephone number of the delivery information receiver.

12. The delivery system according to claim 10, further comprised of the storage storing at least one of an e-mail address and a telephone number of the delivery information receiver.

13. The delivery system according to claim 9, further comprised of the reader part comprising a bar code reader, and the bar code reader providing the read delivery information through a network to the server.

14. The delivery system according to claim 10, with the reader part comprising a barcode reader, and the bar code reader providing the read delivery information through a network to the server.

15. The delivery system according to claim 11, with the server comprising an e-mail sender providing the delivery information through an e-mail to the information receiver.

16. The delivery system according to claim 12, with the server comprising an e-mail sender providing the delivery information through an e-mail to the information receiver.

17. The delivery system according to claim 11, with the server comprising a short message service sender providing the delivery information to the delivery information receiver through a short message service.

18. The delivery system according to claim 12, with the server comprising a short message service sender providing the delivery information to the delivery information receiver through the short message service.

19. The delivery system according to claim 9, with the delivery information receiver being at least one of a sender and the receiver of the goods.

20. A method for providing delivery information on goods, comprising the steps of:
transferring information read from storage mediums attached on goods to a server through a network, the information including information of a receiver to receive the delivery information on the goods; and
providing the delivery information on the goods through the network to the delivery information receiver according to the receiver information by the server.

21. The method of claim 20, with the step of providing the delivery information being through electronic mail of the information to the delivery information receiver.
